(19) United States
(12) Patent Application Publication
(10) Pub. No.: US 2013/0339050 A1
(43) Pub. Date: Dec. 19, 2013

(54) MOBILE COMMUNICATION TERMINAL CONFIGURED TO ENHANCE PATIENT SAFETY

(71) Applicant: Timothy Moeller, Charlotte, NC (US)

(72) Inventor: Timothy Moeller, Charlotte, NC (US)

(73) Assignee: Honeywell International Inc. doing business as (d.b.a) Honeywell Scanning and Mobility, Fort Mill, SC (US)

(21) Appl. No.: 13/495,747

(22) Filed: Jun. 13, 2012

(51) Int. Cl. G06Q 50/24

(52) U.S. Cl. 705/3

(57) ABSTRACT

A mobile communication terminal can comprise a housing, a microprocessor disposed within the housing, a communication interface, an encoded information reading (EIR) device, and a coupling device for mechanically coupling the mobile communication terminal to the patient's body and/or a physical structure sustaining the patient's body. The mobile communication terminal can be configured to produce a message identifying the treatment by decoding optical decodable indicia or an RFID tag attached to a physical item associated with the treatment. The message can comprise the patient identifier, the treatment identifier and/or the treatment dosage. The mobile communication terminal can be further configured to validate at least one parameter of the treatment by retrieving at least a part of the patient's electronic health record (EHR) stored by the mobile communication terminal and/or an external computer.

### FIELD OF THE INVENTION

The present invention relates generally to mobile communication terminals, and in particular to mobile communication terminals configured to enhance patient safety.

### BACKGROUND OF THE INVENTION

Patient safety is defined by the Institute of Medicine of the National Academies as the prevention of harm caused by errors of commission and omission. Errors of commission include, e.g., administering a wrong dose of a medication and administering a medication at a wrong time. Errors of omission occur when a necessary treatment is not provided to a patient.

### SUMMARY OF THE INVENTION

In one embodiment, there is provided a mobile communication terminal for enhancing patient safety. The mobile communication terminal can comprise a housing, a microprocessor disposed within the housing, a communication interface, an encoded information reading (EIR) device, and a coupling device for mechanically coupling the mobile communication terminal to the patient's body and/or a physical structure sustaining the patient's body. The mobile communication terminal can be configured to produce a message identifying a treatment administered to the patient, by decoding optical decodable indicia and/or an RFID tag attached to a physical item associated with the treatment. The message can comprise the patient identifier, the treatment identifier and/or the treatment dosage. The mobile communication terminal can be further configured to validate at least one parameter of the treatment by retrieving at least a part of the patient's electronic health record (EHR) stored by the mobile communication terminal and/or an external computer.

In another embodiment, there is provided a mobile communication terminal for enhancing patient safety. The mobile communication terminal can comprise a housing, a microprocessor disposed within the housing, a communication interface, and an encoded information reading (EIR) device. The mobile communication terminal can be configured to authenticate the patient reading a first RFID tag assigned to said patient and/or reading first optical decodable indicia attached to a body of said patient. The mobile communication terminal can be configured to produce a message identifying a treatment administered to the patient, by decoding optical decodable indicia and/or an RFID tag attached to a physical item associated with the treatment. The message can comprise the patient identifier, the treatment identifier and/or the treatment dosage. The mobile communication terminal can be further configured to validate at least one parameter of the treatment by retrieving at least a part of the patient's electronic health record (EHR) stored by the mobile communication terminal and/or an external computer.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 schematically illustrates various aspects and functions of the functionality of the mobile communication terminal described herein;

FIGS. 2a-2c schematically illustrate one embodiment of the mobile communication terminal described herein;

FIG. 3 schematically illustrates mechanically coupling the mobile communication terminal described herein to a patient's bed;

FIG. 4 schematically illustrates one embodiment of the mobile communication terminal described herein, having a wearable form factor;

FIG. 5 depicts a component-level diagram of the mobile communication terminal described herein;

FIG. 6 depicts a network-level layout of a data collection system utilizing mobile communication terminals; and

FIGS. 7a-7b depict flowcharts of illustrative embodiments of various methods performed by the mobile communication terminal described herein;

The drawings are not necessarily to scale, emphasis instead generally being placed upon illustrating the principles of the invention. In the drawings, like numerals are used to indicate like parts throughout the various views.

### DETAILED DESCRIPTION OF THE INVENTION

“Communication network” or “network” herein shall refer to a set of hardware and software components implementing a plurality of communication channels between two or more computers. A network can be provided, e.g., by a local area network (LAN), or a wide area network (WAN). While different networks can be designated herein, it is recognized that a single network as seen from the network layer of the OSI model can comprise a plurality of lower layer networks, i.e., what can be regarded as a single Internet Protocol (IP) network, can include a plurality of different physical networks.

“Computer” herein shall refer to a programmable device for data processing, including a central processing unit (CPU), a memory, and at least one communication interface. For example, in one embodiment, a computer can be provided by an Intel-based server running Linux operating system. In another embodiment, a computer can be provided by a virtual server, i.e., an isolated instance of a guest operating system running within a host operating system. In a yet another embodiment, a computer can be provided by an encoded information reading (EIR) terminal. In a yet another embodiment, a computer can be provided by a personal digital assistant (PDA). In a yet another embodiment, a computer can be provided by a smartphone.

“Decodable indicia” herein shall refer to an encoded representation, such as the representation in a bar code symbology, of a message string comprising alphanumeric and non-alphanumeric characters. Decodable indicia can be used to convey information, such as the identification of the source and the model of a product, for example in a EPC bar code that can comprises a plurality of encoded symbol characters representing numerical digits.

“Message” herein shall refer to a byte sequence or a character string comprising alphanumeric and/or non-alphanumeric characters.

“Process” herein shall refer to an instance of a computer program that is being executed; in some operating systems, several processes can be instantiated simultaneously. In some operating systems, several processes can be executed concurrently. In some operating systems, several processes can be instantiated simultaneously from the same computer program.

Errors of commission in hospital patient safety including patient misidentification, medication misidentification, wrong dosage, and wrong timing can be prevented by patient safety technologies. However, the ability of medical staff to focus on patient case can suffer when burdened with, or distracted by, additional devices to carry, and/or error-prone manual input steps. To ease the burden imposed by the patient safety technology, some medical staff members employ “workarounds” in using the patient safety systems, which can make the systems ineffective in preventing errors in patient care.

In one embodiment, there is provided a mobile communication terminal associated with a patient at the point-of-care, which obviates the need for medical staff to carry additional patient safety devices and/or perform manual input steps.

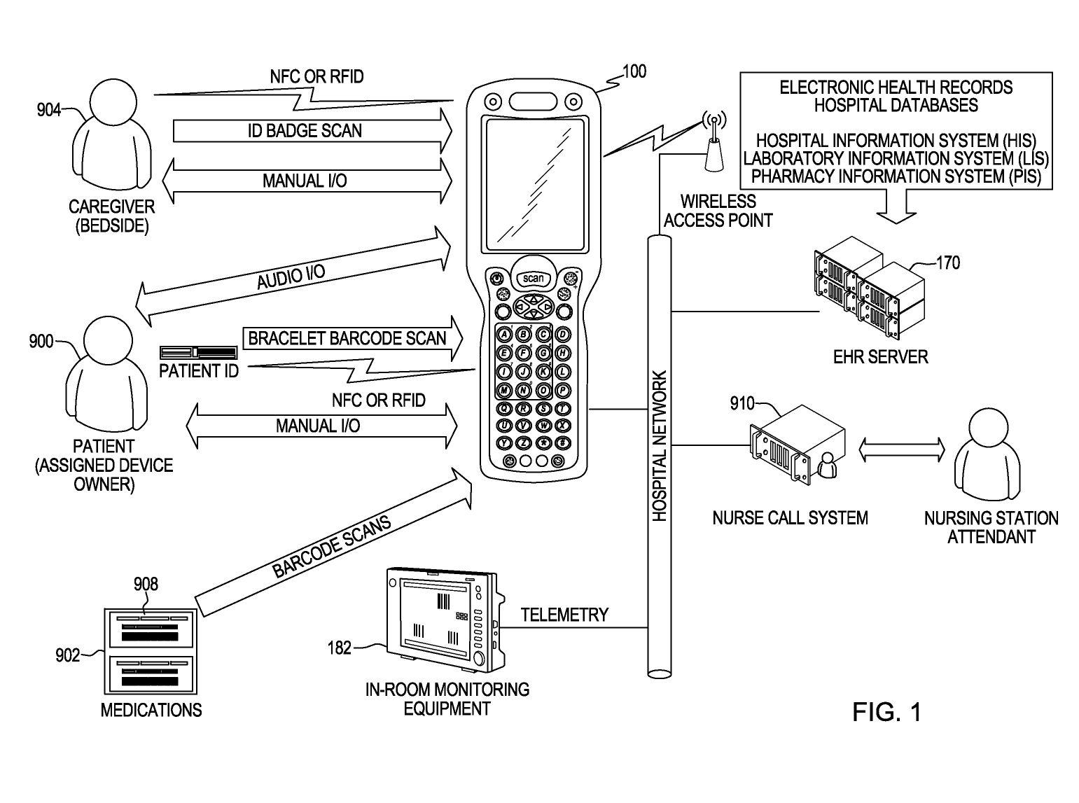

As schematically illustrated by FIG. 1, mobile communication terminal 100 can be logically and/or physically associated with patient 900. In one illustrative embodiment, mobile communication terminal 900 can be assigned to patient 900 upon the patient's admission, and can be mechanically coupled to the patient's body or the patient's bed. In another illustrative embodiment, mobile communication terminal can have a form factor of a wearable device. In a further illustrative embodiment, the mobile communication terminal can be assigned to a patient and can require the patient authentication each time the terminal is used by medical staff. The patient authentication can be performed, for example, by reading an RFID tag wearable by the patient, by scanning a bar code label attached to the patient's body, or by the patient's entering a secret word using the terminal's graphical user interface. Other ways of authenticating the patient are discussed herein infra.

In a further aspect, mobile communication terminal 100 can be used to validate a treatment 902 administered to the patient, by reading and decoding a label (e.g., a bar code label 904 or an RFID label) attached to a physical item associated with the treatment. The physical item can be provided, e.g., by a container containing a dose of medication to be administered to the patient. Upon reading and decoding treatment label 904, mobile communication terminal 100 can validate the treatment against the patient's electronic health record (EHR) which can be stored locally within the memory of terminal 100 and/or on an external computer 171 accessible via an in-hospital network 110 and/or a wide area network (not shown in FIG. 1). The treatment aspects to be validated can include, for example, the treatment identifier, the treatment dosage, compatibility of the treatment with other treatment being received by the patient, compatibility of the treatment with the patient's known allergies, and the purported time of administering the treatment. The mobile communication terminal can log the treatment validation event in a local and/or remote log file, and can alert the medical staff of any unsuccessful validation attempt.

The mobile communication terminal be also used to store, retrieve, and/or present the patient's EHR, including, e.g., demographic records, medical history records, medication records, allergy records, immunization records, laboratory test results, radiology images, vital sign records, billing records, etc.

In a further aspect, the mobile communication terminal can restrict the access to patient's EHR and treatment validation functionality to authenticated operators only. In some embodiments, the authentication of medical staff can be performed automatically by detecting and reading an RFID tag or IR tag wearable by a member of the medical staff 908.

In some embodiments, the mobile communication terminal can be integrated with other in-room equipment, hospital systems, and networks. In one illustrative embodiment, mobile communication terminal 100 can be communicatively coupled via hospital network 120 to nurse call system 910 to provide the nurse call functionality. In another illustrative embodiment, mobile communication terminal 100 can be communicatively coupled via hospital network 120 to in room monitoring equipment 182.

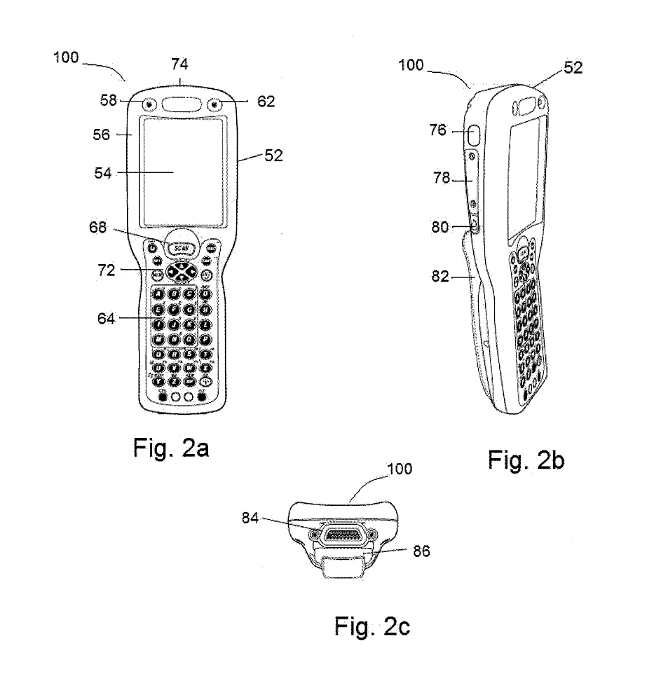

One embodiment of the disclosed mobile communication terminal is shown in in FIGS. 2a (front panel view), 2b (side panel view), and 2c (bottom panel view). A skilled artisan would appreciate that fact that other form factors of the housing of the mobile communication terminal are within the scope of this disclosure.

The mobile communication terminal 100 can comprise a housing 52 within which other components of mobile communication terminal 100 can be disposed. In some embodiments, housing 52 can be manufactured using hospital-grade materials.

A display 54 can be disposed on the front panel 56. Also disposed on the front panel 56 can be a decode LED 58, a scan LED 62, and a keyboard 64 including a scan key 68 and navigation keys 72. An imaging window 74 can be disposed on the top panel of the housing 52. Disposed on the side panel (best viewed in FIG. 2b) can be an infra-red communication port 76, an access door to a secure digital (SD) memory interface 78, an audio jack 80, and a hand strap 82.

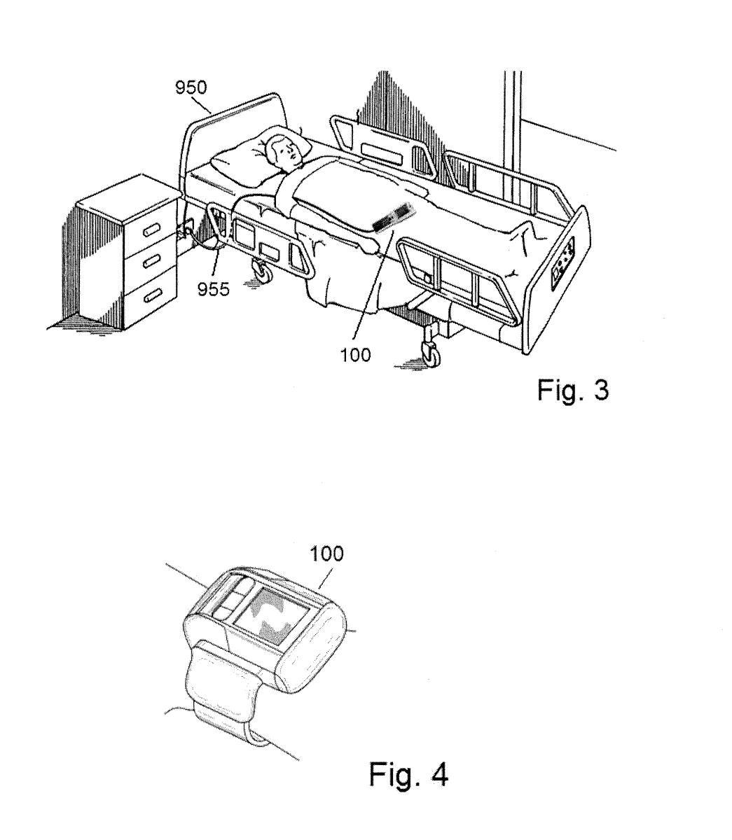

In some embodiments, the mobile communication terminal can comprise a coupling device for mechanically coupling the terminal to the patient's body or to a physical structure sustaining the patient's body, e.g., the patient's bed. FIG. 3 schematically illustrates mobile communication terminal 100 being mechanically coupled to the patient's bed 950 by a cable 955.

In some embodiments, the coupling device can be provided by a belt configured to tether the mobile communication terminal to the patient's body or the patient's bed. In the illustrative embodiments of FIG. 1, the mobile communication terminal can comprise a multi-pin mechanical connector 84 and a belt clip 86 disposed on the bottom panel (best viewed in FIG. 2c).

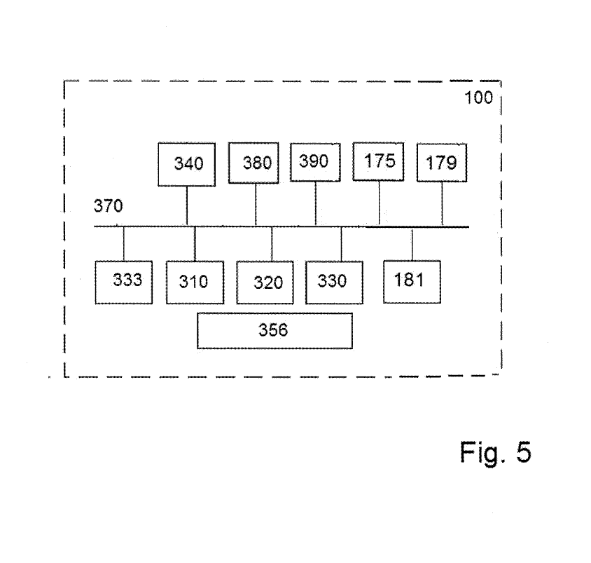

In one embodiment, schematically illustrated by FIG. 4, mobile communication terminal 100 can be provided in a wearable form factor. A skilled artisan would appreciate the fact that other devices and form factors facilitating mechanically coupling the terminal to the patient's body or to a physical structure sustaining the patient's body are within the scope of this disclosure.

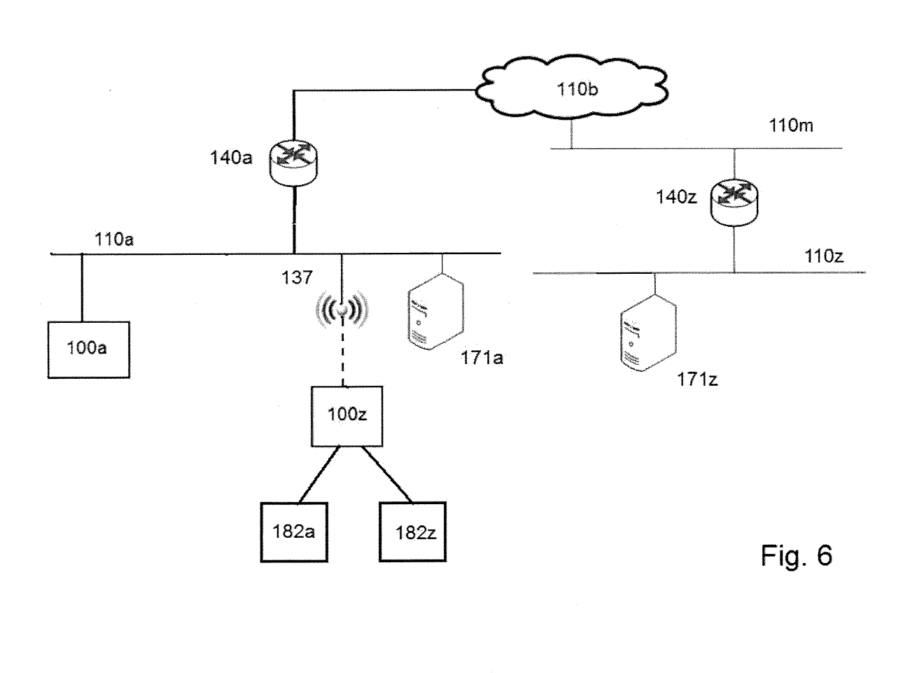

Component-level diagram of one embodiment of a mobile communication terminal is now being described with references to FIG. 5. The mobile communication terminal 100 can comprise at least one microprocessor 310 and a memory 320, both coupled to the system bus 370. The microprocessor 310 can be provided by a general purpose microprocessor or by a specialized microprocessor (e.g., an ASIC). In one embodiment, mobile communication terminal 100 can comprise a single microprocessor which can be referred to as a central processing unit (CPU). In another embodiment, mobile communication terminal 100 can comprise two or more microprocessors, for example, a CPU providing some or most of a mobile communication terminal functionality and a specialized microprocessor performing some specific functionality. A skilled artisan would appreciate the fact that other schemes of processing tasks distribution among two or more microprocessors are within the scope of this disclosure.

Mobile communication terminal 100 can further comprise one or more communication interfaces 340 communicatively coupled to the system bus 370. In some embodiments, mobile communication terminal 100 can comprise one or more wireless communication interfaces. A wireless communication interface can be configured to support, for example, but not limited to, the following protocols: at least one protocol of the IEEE 802.11/802.15/802.16 protocol family, at least one protocol of the HSPA/GSM/GPRS/EDGE protocol family, TDMA protocol, UMTS protocol, LTE protocol, and/or at least one protocol of the CDMA/1x EV-DO protocol family. In some embodiments, mobile communication terminal 100 can comprise one or more wired communication interfaces (e.g., USB, RS/232, RS/485, and/or Ethernet).

Mobile communication terminal 100 can further comprise a battery 356. In one embodiment, the battery 356 can be provided by a replaceable rechargeable battery pack. The mobile communication terminal 100 can further comprise a GPS receiver 380. The mobile communication terminal 100 can further comprise at least one connector 390 configured to receive a subscriber identity module (SIM) card.

Mobile communication terminal 100 can further comprise an imaging device 330, provided, for example, by a two-dimensional imager. Imaging device 330 can be configured to acquire and store in the terminal's memory still and/or moving images.

In some embodiments, mobile communication terminal 100 can further comprise one or more encoded information reading (EIR) devices 333. The EIR device can be provided, for example, by a bar code reading device, an RFID reading device, an NFC reading device, and/or a magnetic card reading device. The EIR device can be configured to output raw message data containing an encoded message and/or output decoded message data corresponding to an encoded message.

In some embodiments, a mobile communication terminal 100 can further comprise a user interface including a display adapter 175 and a keyboard 179. In some embodiments, a mobile communication terminal 100 can further comprise an audio output device, e.g., a speaker 181.

As noted herein supra, mobile communication terminal 100 can be logically and/or physically associated with a patient. In one illustrative embodiment, a mobile communication terminal can be assigned to an in-patient upon the patient's admission, and can be mechanically coupled to the patient's body or the patient's bed. In another illustrative embodiment, mobile communication terminal can have a form factor of a wearable device. In a further illustrative embodiment, the mobile communication terminal can be assigned to a patient and can require the patient authentication each time the terminal is used by medical staff. The patient authentication can be performed, for example, by reading an RFID tag wearable by the patient, by scanning a bar code label attached to the patient's body, or by the patient's entering a secret word using the terminal's graphical user interface. In a further illustrative embodiment, the mobile communication terminal can be logically coupled to a patient by associating the terminal's MAC address, IP address or other identifier with the patient's identifier. The association can be reflected by a record in a database stored by an external computer (e.g., a server storing electronic health records).

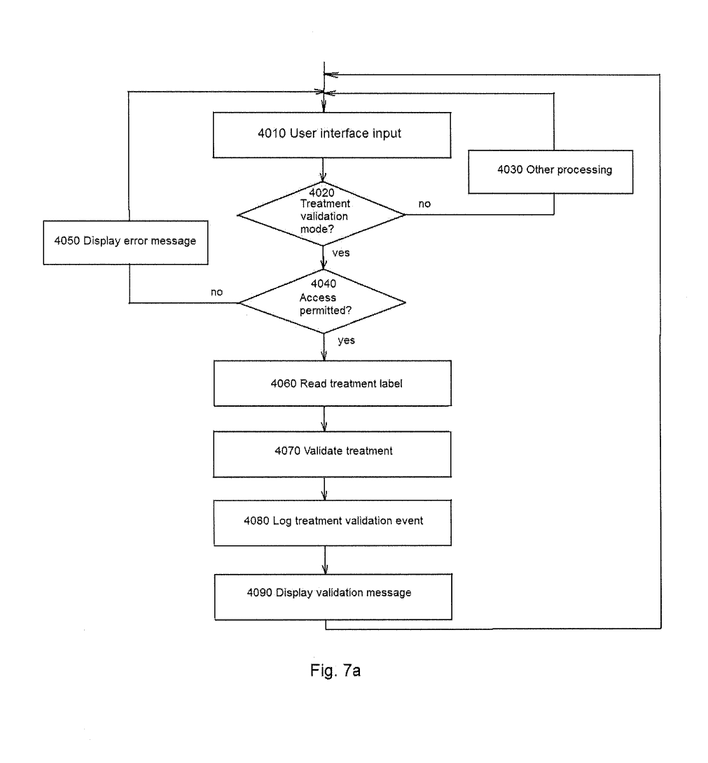

In a further aspect, a mobile communication terminal 100 can be incorporated in a data processing system. One embodiment of the data processing system, schematically shown in FIG. 6, can include a plurality of mobile communication terminals 100a-100z in communication with a plurality of interconnected networks 110a-110z. Mobile communication terminal 100 (provided by one of mobile communication terminals 100a-100z) can establish a communication session with one or more external computers 171a-171b.

In the illustrative embodiment of FIG. 6, mobile communication terminal 100a can be connected to the hospital local area network (LAN) 110 over an Ethernet communication interface. Mobile communication terminal 100z can be connected to the hospital local area network (LAN) 110 over a wireless communication interface connecting to an IEEE802.11-compatible access point 137. Mobile communication terminals 100a and 100z can be in communication with the hospital server 171a over hospital LAN 110. Mobile communication terminals 100a and 100z can also be in communication with the remote server 171z over one or more networks 110a-110z (including the Internet 110b) interconnected by one or more routers 140a-140z. A skilled artisan would appreciate the fact that other methods of providing interconnectivity between a mobile communication terminal 100 and the external computer 171a or 171b relying upon LANs, WANs, virtual private networks (VPNs), and/or other types of network are within the scope of this disclosure.

In the illustrative embodiment of FIG. 6, mobile communication terminal can be in communication with one or more a vital sign monitoring devices 182a-182z via one or more wired interfaces (e.g., USB or Ethernet interfaces).

In one embodiment, the communications between a mobile communication terminal 100 and the external computer 171a or 171b can comprise a series of requests and responses transmitted over one or more TCP connections. A skilled artisan would appreciate the fact that using various transport and application level protocols is within the scope and the spirit of the invention.

In one illustrative embodiment, at least one of the messages transmitted by mobile communication terminal 100 to external computer 171 can include a byte sequence representing an image of decodable indicia (e.g., a bar code attached to a medication container). In another illustrative embodiment, at least one of the messages transmitted by mobile communication terminal 100 to external computer 171 can include a byte sequence representing decoded message data corresponding to a message encoded into a label attached to a medication container. Mobile communication terminal 100 can transmit the byte sequence to external computer 171 for validating the treatment to be administered to a patient against the patient's EHR stored by external computer 171. The treatment aspects to be validated can include, for example, the treatment identifier, the treatment dosage, compatibility of the treatment with other treatment being received by the patient, compatibility of the treatment with the patient's known allergies, and the purported time of administering the treatment. Responsive to receiving a treatment validation response from external computer 171, mobile communication terminal 100 can log the treatment validation event in a local and/or remote log file, and can alert the medical staff of any unsuccessful validation attempt.

In another illustrative embodiment, mobile communication terminal 100 can be configured, responsive to a user interface action, to present at least part of the patient's EHR to the operator of the terminal 100, by retrieving the requested EHR from a local and/or a remotely residing database. In case of remotely residing EHR database, at least one of the messages transmitted by mobile communication terminal 100 to external computer 171 can include an EHR request comprising a patient identifier. Responsive to receiving the requested EHR, mobile communication terminal 100 can present at least a part of the received EHR to the operator of the terminal, by displaying at least part of the EHR, printing at least part of the EHR, or generating a voice message comprising at least a part of the EHR.

In another illustrative embodiment, mobile communication terminal 100 can be configured to automatically authenticate a medical staff member responsive to successfully reading and validating an RFID tag assigned to the medical staff member. RFID tag validation can be performed by retrieving one or more access permissions (e.g., represented by user groups) associated with the user identifier encoded by the RFID tag. Permission to access an application or a function executable by the mobile communication terminal can be granted based on group affiliation of a user requesting the access: to access a certain application or function, membership in a pre-defined user group can be required. For example, to access the treatment validation function, membership in TreatmentValidation group can be required. Thus, in ascertaining whether the currently logged in user has a right to access the treatment validation function, the mobile communication terminal should ascertain whether the user is a member of the TreatmentValidation group.

In a further aspect, the user and group information can be stored in a centralized user directory. In some embodiments, at least the user and group information can at least partially be periodically replicated to the mobile communication terminal, thus eliminating the need to access the centralized user directory for validating user access permissions responsive to every user's attempt to access a function or an application.

RFID tag validation can be performed by retrieving one or more access permissions (e.g., represented by user groups) associated with the user identifier encoded by the RFID tag. Validation of the user identifier and/or retrieving one or more access permission associated with the user identifier can be performed by the mobile communication terminal by querying a local and/or remote user directory. In case of remotely residing user directory, at least one of the messages transmitted by mobile communication terminal 100 to external computer 171 can include a byte sequence representing decoded message data corresponding to a message encoded into a badge wearable by a medical staff member.

In a further aspect, mobile communication terminal 100 can be configured, responsive to successfully authenticating an operator of the terminal by reading and validating an RFID tag assigned to the operator, to repeatedly attempt to read RFID tag, and log off the previously authenticated operator responsive to failing to successfully read the RFID tag assigned to the operator.

In some embodiments, mobile communication terminal 100 can be configured to log medical staff authentication events in a local and/or remote log file.

In one illustrative embodiment, mobile communication terminal 100 can be integrated into a hospital signaling system and can be configured to transmit a notification to one or more members of medical staff responsive to detecting a pre-determined condition. For example, responsive to a user interface action (such as Call button pressed by the patient), mobile communication terminal 100 can transmit a message to an external computer, thus causing the hospital signaling system to transmit a notification to the nursing station.

As noted herein supra, mobile communication terminal 100 can be in communication with one or more a vital sign monitoring devices 182a-182z. In one illustrative embodiment, responsive to a vital sign falling outside a pre-determining range, mobile communication terminal 100 can transmit a message to an external computer, thus causing the hospital signaling system to transmit a message to an alphanumeric pager assigned to the attending physician.

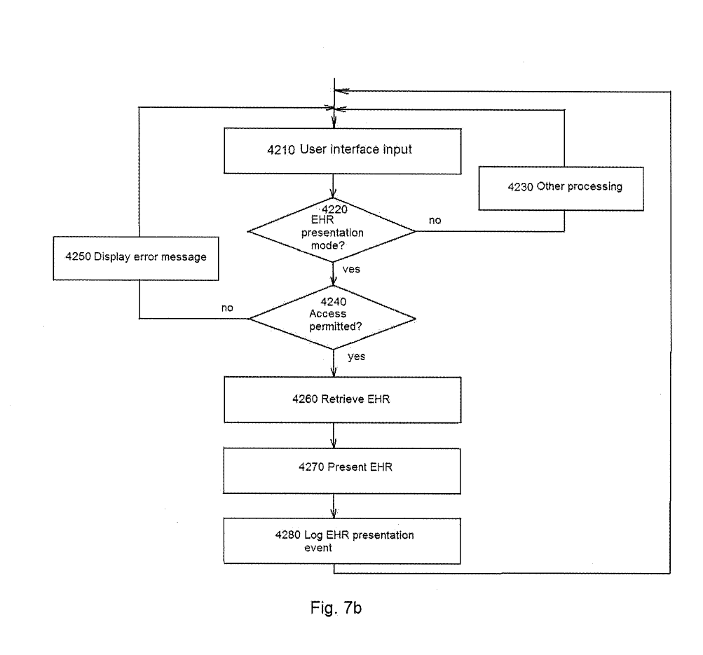

One illustrative embodiment of a method of validating a treatment to be administered to a patient is now being described with references to FIG. 7a.

Processing commences by the mobile communication terminal receiving, within the user interface input loop 4010-4020, a user interface command selecting a treatment validation mode. In one illustrative embodiment, the treatment validation mode can be selected by the operator of the terminal pressing Scan button and scanning a bar code label attached to a medication container. A skilled artisan would appreciate the fact that other methods of selecting a treatment validation mode are within the scope of this disclosure.

Responsive to ascertaining, at step 4040, that a user is currently logged in to the mobile communication terminal, and that the currently logged in user is authorized to access the treatment validation function for the patient associated with the mobile communication terminal, the processing can continue at step 4060. As noted herein supra, the mobile communication terminal 100 can be configured to automatically authenticate and log in a medical staff member responsive to successfully reading and validating an RFID tag assigned to the medical staff member. RFID tag validation can be performed by retrieving from a local or remote user directory one or more access permissions associated with the user identifier encoded by the RFID tag.

Responsive to ascertaining, at step 4040, that no user is currently logged in to the mobile communication terminal, or that the currently logged in user is not authorized to access the treatment validation function, at step 4050 a message can be displayed by the mobile communication terminal, and the method can loop back to step 4010.

At step 4060, the mobile communication terminal can read and decode a label (e.g., a bar code label or an RFID label) attached to a physical item associated with the treatment (e.g., a container containing a dose of medication to be administered to the patient). The mobile communication terminal can, by decoding optical decodable indicia or an RFID tag attached to a physical item associated with the treatment, produce a message comprising the patient identifier, the treatment identifier and/or the treatment dosage.

At step 4070, the mobile communication terminal can validate the treatment to be administered to a patient against the patient's EHR stored locally by the mobile communication terminal and/or remotely by an external computer. In the latter case, mobile communication terminal can transmit to an external computer decoded message data corresponding to a message encoded into a label attached to a physical item. As noted herein supra, the treatment aspects to be validated can include, for example, the treatment identifier, the treatment dosage, compatibility of the treatment with other treatment being received by the patient, compatibility of the treatment with the patient's known allergies, and the purported time of administering the treatment.

At step 4080, the mobile communication terminal can log the treatment validation event in a local and/or remote log file.

At step 4090, the mobile communication terminal can display a successful validation message or alert the medical staff of an unsuccessful validation attempt, and the method can loop back to step 4010.

One illustrative embodiment of a method of presenting an EHR by a mobile communication terminal is now being described with references to FIG. 7b.

Processing commences by the mobile communication terminal receiving, within the user interface input loop 4210-4220, a user interface command selecting an EHR presentation mode. In one illustrative embodiment, the EHR presentation mode can be selected by the operator of the terminal pressing a dedicated button or a combination of buttons. In one illustrative embodiment, the user can select one or more EHR parts to be presented. A skilled artisan would appreciate the fact that other methods of selecting an EHR presentation mode are within the scope of this disclosure.

Responsive to ascertaining, at step 4240, that a user is currently logged in to the mobile communication terminal, and that the currently logged in user is authorized to access the EHR presentation function, the processing can continue at step 4260. As noted herein supra, the mobile communication terminal 100 can be configured to automatically authenticate and log in a medical staff member responsive to successfully reading and validating an RFID tag assigned to the medical staff member. RFID tag validation can be performed by retrieving from a local or remote user directory one or more access permissions associated with the user identifier encoded by the RFID tag.

Responsive to ascertaining, at step 4240, that no user is currently logged in to the mobile communication terminal, or that the currently logged in user is not authorized to access the EHR presentation function for the patient associated with the mobile communication terminal, at step 4250 a message can be displayed by the mobile communication terminal, and the method can loop back to step 4210.

At step 4260, the mobile communication terminal can retrieve the requested parts of the EHR from a local and/or remote EHR database.

At step 4270, the mobile communication terminal can at least a part of the received EHR to the operator of the terminal, by displaying, printing and/or or generating a voice message comprising one or more parts of the EHR selected by the user.

At step 4280, the mobile communication terminal can log the EHR access event in a local and/or remote log file, and the method can loop back to step 4210.

While the present invention has been particularly shown and described with reference to certain exemplary embodiments, it will be understood by one skilled in the art that various changes in detail may be affected therein without departing from the spirit and scope of the invention as defined by claims that can be supported by the written description and drawings. Further, where exemplary embodiments are described with reference to a certain number of elements it will be understood that the exemplary embodiments can be practiced utilizing less than the certain number of elements.

A small sample of systems, methods, and apparata that are described herein is as follows:

A1. A mobile communication terminal for enhancing safety of a patient, said mobile communication terminal comprising:

a housing;

a microprocessor disposed within said housing;

a communication interface communicatively coupled to said microprocessor, said communication interface at least partially disposed within said housing;

an encoded information reading (EIR) device configured to output at least one of: raw message data comprising an encoded message, decoded message data corresponding to an encoded message;

a coupling device for mechanically coupling said mobile communication terminal to at least one of: a body of said patient, a physical structure sustaining a body of said patient;

wherein said mobile communication terminal is configured to produce a message identifying a treatment administered to said patient, by decoding one of: optical decodable indicia attached to a physical item associated with said treatment, an RFID tag attached to a physical item associated with said treatment;

wherein said message comprises at least one of: a treatment identifier, a treatment dosage; and

wherein said mobile communication terminal is further configured to validate at least one parameter of said treatment by retrieving at least a part of an electronic health record of said patient stored by at least one of: said mobile communication terminal, an external computer.

A2. The mobile communication terminal of (A1), wherein said EIR device is provided by one of: a bar code reading device, a two-dimensional imaging device, an RFID reading device, an NFC reading device, a magnetic card reading device.

A3. The mobile communication terminal of (A1), wherein said at least one parameter of said treatment is selected from the group consisting of: said treatment identifier, said treatment dosage, compatibility of said treatment with other treatments being received by said patient, compatibility of said treatment with known allergies of said patient, and a purported time of administering said treatment.

A4. The mobile communication terminal of (A1), wherein said treatment is provided by a medication; and wherein said physical item is provided by a container containing said medication.

A5. The mobile communication terminal of (A1), wherein said coupling device is provided by a belt configured to tether said mobile communication terminal to patient's body.

A6. The mobile communication terminal of (A1), wherein said physical structure is provided by a hospital bed.

A7. The mobile communication terminal of (A1), further configured, responsive to successfully decoding said decodable indicia, to log a treatment validation event in a log file stored by at least one of: said mobile communication terminal, an external computer.

A8. The mobile communication terminal of (A1) further configured, responsive to a user interface action, to present at least part of said electronic health record by at least one of: displaying said at least part of said electronic health record, printing said at least part of said electronic health record, generating a voice message comprising at least part of said electronic health record.

A9. The mobile communication terminal of (A1) further configured, responsive to authenticating an operator of said mobile communication terminal, to present at least part of said electronic health record by at least one of: displaying said at least part of said electronic health record, printing said at least part of said electronic health record, generating a voice message comprising at least part of said electronic health record.

A10. The mobile communication terminal of (A1), wherein said mobile communication terminal is configured to transmit a notification to an external computer responsive to detecting a pre-determined condition.

A11. The mobile communication terminal of (A1), wherein said pre-determined condition is provided by one of: a user interface action, a parameter value falling outside a pre-determined range.

A12. The mobile communication terminal of (A1), wherein said mobile communication terminal is further configured to automatically authenticate an operator of said mobile communication terminal upon successfully reading an RFID tag assigned to said operator.

A13. The mobile communication terminal of (A1), wherein said mobile communication terminal is further configured to automatically log off a previously authenticated operator of said mobile communication terminal responsive to failing to successfully read an RFID tag assigned to said operator.

A14. The mobile communication terminal of (A1), wherein said electronic health record comprises at least one of: one or more demographics records, one or more medical history records, one or more medication records, one or more allergy records, one or more immunization records, one or more laboratory test results, one of more radiology images, one or more vital sign records, and one of more billing records.

A15. The mobile communication terminal of (A1), further configured, responsive to failing to successfully validate said at least one parameter of said treatment, to alert an operator of said mobile communication terminal by emitting at least one of: an audio alert, a visual alert.

A16. The mobile communication terminal of (A1), wherein said communication interface is provided by at least one of: a wired communication interface, a wireless communication interface.

B1. A mobile communication terminal for enhancing safety of a patient, said mobile communication terminal comprising:

a housing;

a microprocessor disposed within said housing;

a communication interface communicatively coupled to said microprocessor, said communication interface at least partially disposed within said housing;

an encoded information reading (EIR) device configured to output at least one of: raw message data comprising an encoded message, decoded message data corresponding to an encoded message;

wherein said mobile communication terminal is configured to authenticate said patient by at least one of: reading a first RFID tag assigned to said patient, reading first optical decodable indicia attached to a body of said patient;

wherein said mobile communication terminal is further configured to produce a message identifying a treatment administered to said patient, by decoding one of: second optical decodable indicia attached to a physical item associated with said treatment, a second RFID tag attached to a physical item associated with said treatment;

wherein said message comprises at least one of: a patient identifier, a treatment identifier, a treatment dosage; and

wherein said mobile communication terminal is further configured to validate at least one parameter of said treatment by retrieving at least a part of an electronic health record of said patient stored by at least one of: said mobile communication terminal, an external computer.

B2. The mobile communication terminal of claim B1, wherein said EIR device is provided by one of: a bar code reading device, a two-dimensional imaging device, an RFID reading device, an NFC reading device, a magnetic card reading device.

B3. The mobile communication terminal of claim B1, wherein said at least one parameter of said treatment is selected from the group consisting of: said treatment identifier, said treatment dosage, compatibility of said treatment with other treatments being received by said patient, compatibility of said treatment with known allergies of said patient, and a purported time of administering said treatment.

B4. The mobile communication terminal of claim B1, wherein said treatment is provided by a medication; and

wherein said physical item is provided by a container containing said medication.

B5. The mobile communication terminal of claim B1, further configured, responsive to successfully decoding said decodable indicia, to log a treatment validation event in a log file stored by at least one of: said mobile communication terminal, an external computer.

B6. The mobile communication terminal of claim B1 further configured, responsive to a user interface action, to present at least part of said electronic health record by at least one of: displaying said at least part of said electronic health record, printing said at least part of said electronic health record, generating a voice message comprising at least part of said electronic health record.

B7. The mobile communication terminal of claim B1 further configured, responsive to authenticating an operator of said mobile communication terminal, to present at least part of said electronic health record by at least one of: displaying said at least part of said electronic health record, printing said at least part of said electronic health record, generating a voice message comprising at least part of said electronic health record.

B8. The mobile communication terminal of claim B1, wherein said mobile communication terminal is configured to transmit a notification to an external computer responsive to detecting a pre-determined condition.

B9. The mobile communication terminal of claim B1, wherein said pre-determined condition is provided by one of: a user interface action, a parameter value falling outside a pre-determined range.

B10. The mobile communication terminal of claim B1, wherein said mobile communication terminal is further configured to automatically authenticate an operator of said mobile communication terminal upon successfully reading an RFID tag assigned to said operator.

B11. The mobile communication terminal of claim B1, wherein said mobile communication terminal is further configured to automatically log off a previously authenticated operator of said mobile communication terminal responsive to failing to successfully read an RFID tag assigned to said operator.

B12. The mobile communication terminal of claim B1, wherein said electronic health record comprises at least one of: one or more demographics records, one or more medical history records, one or more medication records, one or more allergy records, one or more immunization records, one or more laboratory test results, one of more radiology images, one or more vital sign records, and one of more billing records.

B13. The mobile communication terminal of claim B1, further configured, responsive to failing to successfully validate said at least one parameter of said treatment, to alert an operator of said mobile communication terminal by emitting at least one of: an audio alert, a visual alert.

B14. The mobile communication terminal of claim B1, wherein said communication interface is provided by at least one of: a wired communication interface, a wireless communication interface.

1. A mobile communication terminal for enhancing safety of a patient, said mobile communication terminal comprising:
a housing;
a microprocessor disposed within said housing;
a communication interface communicatively coupled to said microprocessor, said communication interface at least partially disposed within said housing;
an encoded information reading (EIR) device configured to output at least one of: raw message data comprising an encoded message, decoded message data corresponding to an encoded message;
a coupling device for mechanically coupling said mobile communication terminal to at least one of: a body of said patient, a physical structure sustaining a body of said patient;
wherein said mobile communication terminal is configured to produce a message identifying a treatment administered to said patient, by decoding one of: optical decodable indicia attached to a physical item associated with said treatment, an RFID tag attached to a physical item associated with said treatment;
wherein said message comprises at least one of: a patient identifier, a treatment identifier, a treatment dosage; and
wherein said mobile communication terminal is further configured to validate at least one parameter of said treatment by retrieving at least a part of an electronic health record of said patient stored by at least one of: said mobile communication terminal, an external computer.

2. The mobile communication terminal of claim 1, wherein said EIR device is provided by one of: a bar code reading device, a two-dimensional imaging device, an RFID reading device, an NFC reading device, a magnetic card reading device.

3. The mobile communication terminal of claim 1, wherein said at least one parameter of said treatment is selected from the group consisting of: said treatment identifier, said treatment dosage, compatibility of said treatment with other treatments being received by said patient, compatibility of said treatment with known allergies of said patient, and a purported time of administering said treatment.

4. The mobile communication terminal of claim 1, wherein said treatment is provided by a medication; and
wherein said physical item is provided by a container containing said medication.

5. The mobile communication terminal of claim 1, wherein said coupling device is provided by a belt configured to tether said mobile communication terminal to patient's body.

6. The mobile communication terminal of claim 1, wherein said physical structure is provided by a hospital bed.

7. The mobile communication terminal of claim 1, further configured, responsive to successfully decoding said decodable indicia, to log a treatment validation event in a log file stored by at least one of: said mobile communication terminal, an external computer.

8. The mobile communication terminal of claim 1 further configured, responsive to a user interface action, to present at least part of said electronic health record by at least one of:
displaying said at least part of said electronic health record, printing said at least part of said electronic health record, generating a voice message comprising at least part of said electronic health record.

9. The mobile communication terminal of claim 1 further configured, responsive to authenticating an operator of said mobile communication terminal, to present at least part of said electronic health record by at least one of: displaying said at least part of said electronic health record, printing said at least part of said electronic health record, generating a voice message comprising at least part of said electronic health record.

10. The mobile communication terminal of claim 1, wherein said mobile communication terminal is configured to transmit a notification to an external computer responsive to detecting a pre-determined condition.

11. The mobile communication terminal of claim 10, wherein said pre-determined condition is provided by one of: a user interface action, a parameter value falling outside a pre-determined range.

12. The mobile communication terminal of claim 1, wherein said mobile communication terminal is further configured to automatically authenticate an operator of said mobile communication terminal upon successfully reading an RFID tag assigned to said operator.

13. The mobile communication terminal of claim 1, wherein said mobile communication terminal is further configured to automatically log off a previously authenticated operator of said mobile communication terminal responsive to failing to successfully read an RFID tag assigned to said operator.

14. The mobile communication terminal of claim 1, wherein said electronic health record comprises at least one of: one or more demographics records, one or more medical history records, one or more medication records, one or more allergy records, one or more immunization records, one or more laboratory test results, one of more radiology images, one or more vital sign records, and one of more billing records.

15. The mobile communication terminal of claim 1, further configured, responsive to failing to successfully validate said at least one parameter of said treatment, to alert an operator of said mobile communication terminal by emitting at least one of: an audio alert, a visual alert.

16. A mobile communication terminal for enhancing safety of a patient, said mobile communication terminal comprising:
a housing;
a microprocessor disposed within said housing;
a communication interface communicatively coupled to said microprocessor, said communication interface at least partially disposed within said housing;
an encoded information reading (EIR) device configured to output at least one of: raw message data comprising an encoded message, decoded message data corresponding to an encoded message;
wherein said mobile communication terminal is configured to authenticate said patient by at least one of: reading a first RFID tag assigned to said patient, reading first optical decodable indicia attached to a body of said patient;
wherein said mobile communication terminal is further configured to produce a message identifying a treatment administered to said patient, by decoding one of: second optical decodable indicia attached to a physical item associated with said treatment, a second RFID tag attached to a physical item associated with said treatment;
wherein said message comprises at least one of: a patient identifier, a treatment identifier, a treatment dosage; and
wherein said mobile communication terminal is further configured to validate at least one parameter of said treatment by retrieving at least a part of an electronic health record of said patient stored by at least one of: said mobile communication terminal, an external computer.

17. The mobile communication terminal of claim 16, wherein said EIR device is provided by one of: a bar code reading device, a two-dimensional imaging device, an RFID reading device, an NFC reading device, a magnetic card reading device.

18. The mobile communication terminal of claim 16, wherein said electronic health record comprises at least one of: one or more demographics records, one or more medical history records, one or more medication records, one or more allergy records, one or more immunization records, one or more laboratory test results, one of more radiology images, one or more vital sign records, and one of more billing records.

19. The mobile communication terminal of claim 16, further configured, responsive to failing to successfully validate said at least one parameter of said treatment, to alert an operator of said mobile communication terminal by emitting at least one of: an audio alert, a visual alert.

20. The mobile communication terminal of claim 16, wherein said communication interface is provided by at least one of: a wired communication interface, a wireless communication interface.
